(19) United States
(12) Patent Application Publication
(10) Pub. No.: US 2004/0236665 A1
(43) Pub. Date: Nov. 25, 2004

(54) Repo trading with an increased amount of collateral instruments

(76) Inventors: Daniel Negishi, Stockholm (SE); Susanne Holm, Bromma (SE); Thomas Wester, Ingaro (SE)

Correspondence Address: NIXON & VANDERHYE, PC, 1100 N GLEBE ROAD, 8TH FLOOR, ARLINGTON, VA, 22201-4714, US

(21) Appl. No.: 10/444,092

(22) Filed: May 23, 2003

(51) Int. Cl. G06F 17/60

(52) U.S. Cl. 705/37

(57) ABSTRACT

The invention relates to a method for use in a system for repo trading, with the seller of the repo providing a financial instrument as collateral, and letting the collateral be registered with the system, also comprising letting the system, via an interface function, query the registering party regarding the identity of the collateral by means of a first function in the system. The method also comprises letting said identity of the collateral be sent from the interface function to a second function in the system, said second function keeping track of financial instruments which have been used for repo collateral in the system during a defined period of time. Suitably, the query is made by the first function in the form of a pre-defined template which is sent to the interface function to be filled in by the registering party.

### TECHNICAL FIELD

The present invention refers to the buying and selling of a loans known as repos. By means of the invention, it has become simpler than previously for a system for repo trading to use a large amount of different instruments as collateral for a repo.

### BACKGROUND ART

When a repo (repurchased agreement) is sold, this is usually done via a trading system for repos, i.e. a more or less automated system by means of which buying and selling parties come into contact with each other, and agree on the trading of repos.

In connection with the trade, usually after the repo has been sold, the selling party needs to post collateral to the system through which the repo was sold. Usually, the collateral is in the form of a financial instrument.

Naturally, if a financial instrument is posted to the system as collateral for a repo, the system needs to know if that instrument is valid as collateral or not. In existing systems, this has been checked by the system against a database or some other such list of instruments which are valid for use as collateral.

However, a problem arises if a party who frequently sells repos wishes to choose among a large number of different instruments when it comes to posting collateral. The problem is due to the fact that if the desired number of instruments is high, for example several thousands, the amount of work needed by the system to check the validity of the instrument as collateral becomes prohibitively high, the storage space needed on a computer data base for such an amount of instruments would, for example, become too large, and the speed with which such a database could be accessed would be not be acceptable.

In addition, there would also be an initial cost for the system if it were to be dimensioned for such a large number of instruments for use as collateral before the instruments have been used in the system

### DISCLOSURE OF THE INVENTION

Accordingly, there is a need for a method for use in a system for repo trading, by means of which method it would be possible to choose from among a more or less arbitrarily high number of different instruments, without causing a prohibitively large amount of work when checking the instrument's validity for use as collateral.

This need is addressed by the present invention in that it discloses a method for use in a system for repo trading between a seller and a buyer, with the seller of the repo providing collateral for said repo in the form of a financial instrument, the method comprising the step of letting the seller or the buyer register the collateral with the system. In addition, the method comprises the step of letting the system, via an interface function, query the registering party as to the identity of the collateral, with the query being made by a first function in the system. Furthermore, the identity of the collateral is sent from the interface function to a second function in the system, with the second function keeping track of financial instruments which have been used for repo collateral in the system during a defined period of time.

In this manner, the first function can be a function in the system which would normally keep track of all instruments used for repo collateral, but which would become “overloaded” by a large number of such instruments. Since this function, by means of the method according to the invention, simply poses a question to one of the parties—usually the selling party—any number of instruments can be handled.

Since, the identity of the collateral is sent from the interface function to a second function in the system, this second function can be given the task of keeping track of financial instruments which have been used for repo collateral in the system during a defined period of time. Thus, not all instruments which can be used need to be stored by this second function. In addition, if there is an attempt to use an instrument which has not been used for collateral previously, or during a predefined period of time, the second function can check the validity of the instrument as collateral.

Preferably, the query which is made by the first function can be in the form of a pre-defined template which is sent to the interface function, to be filled in by the registering party. Thus, the first function which stores instruments used for trading in the system need only keep track of a template which will be sent to the user.

### BRIEF DESCRIPTION OF THE DRAWINGS

The invention will be described in more detail below, with reference to the appended drawings, which are

FIG. 1 is a schematic overview of a system in which the invention can be applied, and

FIG. 2 is a flowchart which shows some of the main steps of a method according to the invention.

### EMBODIMENTS

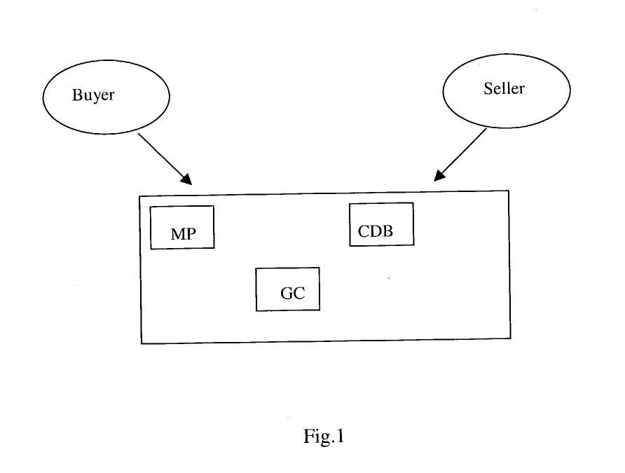

In FIG. 1, a rough overview of a system for trading of repos is shown. In FIG. 1, two users of the system are shown, A and B, although the system can naturally have a much larger number of users, the fact that only two users are shown is merely for the sake of clarity.

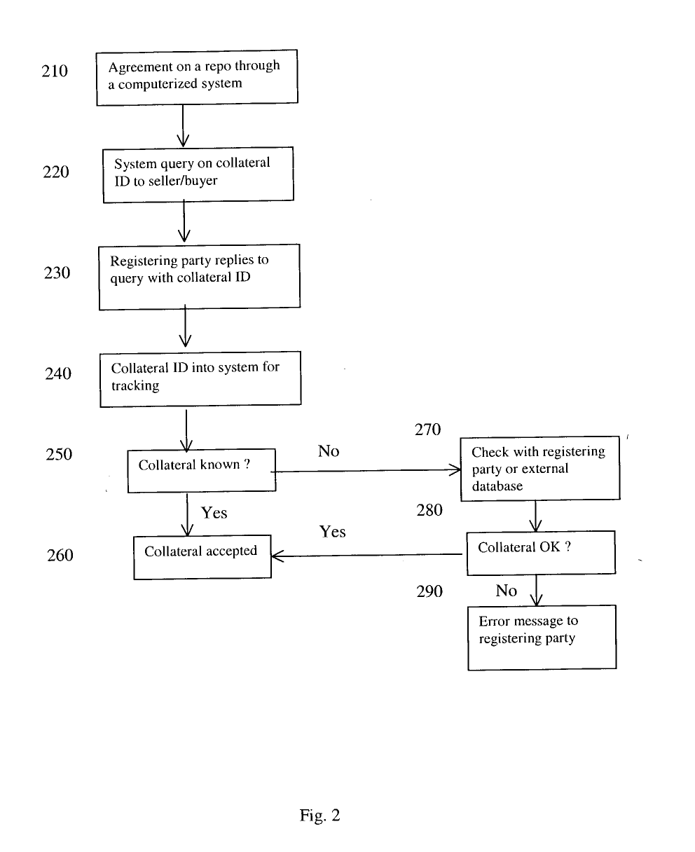

Throughout this description, where appropriate, reference will be made to the reference numbers of the corresponding boxes in the flowchart shown in FIG. 2, said numbers being in the range of 200-290.

Assume that a first party, A makes an offer, via the system, to sell a repo for a certain amount and a certain interest. A second party, B, uses the system to express a desire to buy the repo in question. The “match” between buyer and seller is made in the system, 210, suitably via a dedicated function known as the Matching Processor (MP).

At some point in time, usually after the trade has been agreed upon, one of the parties, A or B, suitably and usually the selling party, needs, 220, to furnish the system with data regarding the collateral he wishes to post for the repo. Usually, a financial instrument will be used as collateral for a repo. A function in the system, here known as the Common Data Base (CDB), keeps track of all of the financial instruments which are traded in the system, a system which can also function, for example, as a normal stock exchange.

A problem can arise if the selling party wishes to choose from a large number of instruments when it comes to posting collateral. The CDB-function would then normally have to keep track of this large number of instruments, some of which might only be used quite rarely. Since the rest of the system poses demands on the CDB to function quickly and with a minimal amount of storage space, desires by repo traders for the CDB to keep track of a large number of instruments for use as collateral would cause problems. This is especially much so since some repo traders might wish to choose form among as many as 40 000 instruments for use as collateral.

According to the method of the invention, it becomes possible for repo traders to choose from among very large numbers of instruments for use as collateral due to the following principle:

Each of the traders interfaces with the system via a local application known as the GC-allocator. The GC sends a query, 220, in the form of a notification, to the party that has the responsibility for registering which instrument that serves as collateral for that particular repo, a query which is presented to the party via the GC_allocator. The query is in the form of a template, which has preferably been defined by the operator of the system.

The nature of the template, i.e. the details which the selling party—in this example—will have to fill in, 230, will now be described. The exact details comprised in the template can of course be varied within the scope of the invention.

Four examples of parameters which could be used in a preferred embodiment of the invention to identify a financial instrument for use as collateral are:

ISIN—an international code identifying the instrument

NAME—the name of the instrument

MATURITY—expiry of the paper

COUPON—the nominal interest of the instrument in question.

If, for example, the selling party has sold a repo for a certain amount and a certain interest, he uses his system interface, GC_allocator, and sees the template, which he then fills in, 230, using the information requested. The GC_allocator sends the information from the template to the function General Collateral , GC, which checks if the instrument posted as collateral is valid, 240.

One of the validity checks, 250, involves checking to see if this instrument has been used as collateral for repos during a certain period of time. One of the roles of the GC in the system is thus to keep track of all instruments which have been used as collateral for repos during a certain predefined period of time.

If this condition, along with certain other conditions which have been defined by the operator of the system, is satisfied, the instrument is allocated to the repo as collateral, 260.

If, on the other hand, the instrument is not known to the GC, the following will happen: the party that fills in the template is requested by the GC, via the GC_allocator, to provide some additional information, 270, regarding the instrument. If this additional information enables the GC to see that the instrument is valid (280), the collateral is approved. Also, the next time that somebody tries to use this particular instrument as collateral, the GC will accept the instrument without further queries, 250.

If the instrument proposed as collateral is unknown to the GC, an alternative sequence of events is that the GC does not ask the party who provides the information via the template for more information regarding the instrument. Instead, the GC queries, 270, an external source, i.e. external to the system, regarding the validity, 280, of the instrument for use as collateral. This external source might be a stock exchange, which is particularly suitable if the system within which the repos are traded is a stock exchange. The stock exchange, or a data base within the stock exchange, would then provide the GC with information as to the validity of the instrument's use as collateral.

In similarity to that which was described above, the next time the GC receives a request to use that particular instrument as collateral for a repo, the GC will have no need to pose further queries as to the validity of the instrument.

If the further query is sent to a central data base instead of being sent to one of the trading parties, the trading party will then receive a message informing him that the approval of the instrument as collateral is pending, while the GC is awaiting the reply from the central data base. The outcome of the pending query can be either “unknown” i.e. refused, 280, or “OK”, 260.

As can be understood from that which has been described above, it is suitable if the query or notification, 220, which is initially sent to the seller—in the example above—involves filling in only part of the information, for example a code such as the ISIN, regarding the instrument which it is desired to use as collateral. if this information does not enable the system to identify the proposed collateral, additional information is requested by the system.

As stated above, one of the roles of the GC in the system is to keep track of all instruments which have been used as collateral for repos during a certain predefined period of time. At regular intervals corresponding to this interval of time, for example once a week, the GC is purged of all information regarding the validity of certain instruments as collateral for repos. Since the amount of instruments used as collateral during such a period isn't particularly large, the memory space needed for the GC can be kept down, and the GC will also have an acceptable access time.

Regarding the needs on the CDB posed by the method according to the invention, all the CDB needs to store is the template which will be sent to the user's interface, i.e. the GC-collateral.

Thus, by means of the invention, a very large, in fact more or less arbitrarily large number of instruments can be used as collateral for repos, without causing undue burdens on the system.

In addition, it should be noted that the method and system according to the invention, although they have been described as being used for repo trading, can be applied to other commodities, with other kinds of collateral.

Naturally, the division between the functions in the system shown above is not necessary for the invention to be carried out. All of the functions could be carried out by one total function, or the functions could be divided differently, so long as the principle of the invention is carried out.

1. A method for use in a computerized system for repo trading between a seller and a buyer, with the seller of the repo providing collateral for said repo in the form of a financial instrument, comprising the step of enabling the seller or the buyer to register the collateral with the system, additionally comprising the step of enabling the system, via an interface function, to query the registering party as to the identity of the collateral, said query being made by a first function in the system, the method additionally comprising the step of sending said identity of the collateral from the interface function to a second function in the system, said second function keeping track of financial instruments which have been used for repo collateral in the system during a defined period of time.

2. The method of claim 1, according to which the query which is made by the first function is in the form of a pre-defined template which is sent to the interface function to be filled in by the registering party.

3. The method of claim 1, according to which the second function uses the identity of the collateral to update a list of financial instruments which have been used for repo collateral in the system during a defined period of time.

4. The method of claim 1, according to which the second function can deny or approve the use of the instrument whose identity has been given as collateral for the repo.

5. The method of claim 4, according to which, if the collateral is an instrument which is unknown to the second function the registering party is prompted by the second function to supply the second function with additional information regarding the instrument, said additional information being used by the second function as basis for denial or approval.

6. The method of claim 4, according to which, if the collateral is an instrument which is unknown to the second function, the second function sends a query to a database as to the validity of the collateral, and as a reply receives information regarding the collateral.

7. A computerized system for repo trading between a seller and a buyer, with means for enabling the seller of the repo to provide collateral for said repo in the form of a financial instrument, and means for enabling the seller or the buyer to register the collateral with the system, additionally comprising means for enabling the system, via an interface function, to query the registering party as to the identity of the collateral, said query being made by a first function in the system, the system additionally comprising means for enabling said identity of the collateral to be sent from the interface function to a second function in the system, said second function keeping track of financial instruments which have been used for repo collateral in the system during a defined period of time.

8. The system of claim 7, additionally comprising means for enabling the query which is made by the first function to be in the form of a pre-defined template which is sent to the interface function to be filled in by the registering party.

9. The system of claim 7, in which the second function comprises means for using the identity of the collateral to update a list of financial instruments which have been used for repo collateral in the system during a defined period of time.

10. The system of claim 7, in which the second function comprises means for denying or approving the use of the instrument whose identity has been given as collateral for the repo.

11. The system of claim 10, comprising means for enabling the system to see if the proposed collateral is an instrument which is unknown to the second function, and in that eventuality, means for enabling the second function to prompt registering party to supply the second function with additional information regarding the instrument, said additional information being used by the second function as basis for denial or approval.

12. The system of claim 10, comprising means for enabling the system to see if the proposed collateral is an instrument which is unknown to the second function, and in that eventuality, means for enabling the second function to query to a database as to the validity of the collateral, and as a reply receives information regarding the collateral.

13. The use of a system for repo trading between a seller and a buyer, said use comprising the steps of:
the seller of the repo providing collateral for said repo in the form of a financial instrument,
the seller or the buyer registering the collateral with the system,
the registering party receiving a query from the system as to the identity of the proposed collateral,
the query being in the form of a pre-defined template.

14. The use of a system for repo trading as defined in claim 13, additionally comprising the step of the registering part being denied or allowed the use of the instrument whose identity he has given as proposed collateral for the repo.

15. The use of a system for repo trading as defined in claim 13, additionally including the step of, if the proposed collateral is an instrument which is unknown to the system, the registering party is prompted by the system to supply additional information regarding the instrument, said additional information being used by the system as basis for denial or approval.
